(19) United States
(12) Patent Application Publication
(10) Pub. No.: US 2025/0007683 A1
(43) Pub. Date: Jan. 2, 2025

(54) SYSTEM FOR VERIFYING VIRTUAL ECU AND METHOD FOR CORRECTING ERROR THEREOF

(71) Applicant: DRIMAES, INC., Daegu (KR)

(72) Inventors: Woo Hyun SEOL, Seoul (KR); Woo Jin Han, Seoul (KR); An Na Yang, Seongnam-si (KR); In Ho Lee, Seoul (KR); Ji Su Kong, Seoul (KR)

(73) Assignee: DRIMAES, INC., Daegu (KR)

(21) Appl. No.: 18/749,028

(22) Filed: Jun. 20, 2024

(30) Foreign Application Priority Data
Jun. 27, 2023 (KR) 10-2023-0082584

(51) Int. Cl. H04L 7/00; H04L 67/12

(52) U.S. Cl. CPC H04L 7/0016; H04L 67/12

(57) ABSTRACT

Provided is a method for correcting error in a virtual ECU. The method includes: transmitting a timing measurement start signal from an error correction module in a host PC in which a plurality of virtual ECUs are driven to the plurality of virtual ECUs and a real ECU; receiving an operation performance result corresponding to a predetermined task from the virtual ECU and the real ECU; calculating an operation timing error between the virtual ECU and the real ECU based on the operation performance result; detecting correction values for each virtual ECU corresponding to the operation timing error; and transmitting the detected correction values to each virtual ECU.

### CROSS-REFERENCE TO RELATED APPLICATION

THIS APPLICATION CLAIMS PRIORITY TO AND THE BENEFIT OF KOREAN PATENT APPLICATION NO. 10-2023-0082584, FILED ON Jun. 27, 2023, THE DISCLOSURE OF WHICH IS INCORPORATED HEREIN BY REFERENCE IN ITS ENTIRETY.

### BACKGROUND

### 1. Technical Field

The present invention relates to a system for verifying a virtual ECU and a method for correcting error thereof.

### 2. Related Art

AUTOSAR (classic platform) is an abbreviation for Automotive Open System Architecture (hereinafter referred to as AUTOSAR), and is an open standard platform used for automotive software development. The AUTOSAR standardizes the software architecture and communication of a vehicle electronic control unit (hereinafter referred to as ECU) to promote compatibility and reuse between various companies and devices.

Conventionally, when developing and verifying firmware on an actual ECU using the AUTOSAR platform, a test was performed in a real hardware environment. This takes a lot of time and cost, and the development and verification work may be limited depending on the complex test environment configuration and availability of actual hardware.

To solve this problem, a virtualization technology was introduced. A virtualized ECU may emulate a real hardware environment and perform the software development and verification using the same firmware executed on the AUTOSAR platform. This may reduce test time and costs while providing the same operating environment as an actual ECU.

However, when executing a virtual ECU in a PC environment, timing errors in operation with the actual ECU may occur. Because the PC environment has different performance and operating system from actual hardware, it may be difficult to maintain the same timing as the actual ECU. This timing error needs to be corrected because it is an important factor in reproducing problems that occur in the actual operating environment or accurately simulating the operation of the actual ECU.

### SUMMARY

A problem to be solved by the present invention is to provide a system for verifying a virtual ECU and a method for correcting error thereof, which adjusts firmware operation timing between the virtual ECU and a real ECU to maintain the same operation timing as the real ECU as much as possible when the virtual ECU operates in a PC environment.

However, the problem to be solved by the present invention is not limited to the problem described above, and other problems may be present.

According to a first aspect of the present invention to solve the above problem, a method for correcting error in a virtual ECU includes: transmitting a timing measurement start signal from an error correction module in a host PC in which a plurality of virtual ECUs are driven to the plurality of virtual ECUs and a real ECU; receiving an operation performance result corresponding to a predetermined task from the virtual ECU and the real ECU; calculating an operation timing error between the virtual ECU and the real ECU based on the operation performance result; detecting correction values for each virtual ECU corresponding to the operation timing error; and transmitting the detected correction values to each virtual ECU.

According to a second aspect of the present invention, a system for verifying a virtual ECU includes: a plurality of virtual ECUs that operate within a host PC and include a first error correction module; and a second error correction module that is provided in the host PC to transmit a timing measurement start signal to the plurality of virtual ECUs and the real ECU, and when receiving an operation performance result corresponding to a predetermined task from the virtual ECUs and the real ECU, calculates an operation timing error between the virtual ECUs and the real ECU based on the operation performance results, detects correction values for each virtual ECU corresponding to the operation timing error, and then transmits the calculated correction values to each virtual ECU.

In addition, according to a third aspect of the present invention, an error correction module within a host PC equipped with a plurality of virtual ECUs includes: a memory configured to store at least one instruction; and at least one processor configured to execute the at least one instruction stored in the memory. In this case, the processor executes the instruction to transmit a timing measurement start signal to the plurality of virtual ECUs and the real ECU, and when the operation performance result corresponding to the predetermined task are received from the virtual ECU and the real ECU, calculate an operation timing error between the virtual ECU and the real ECU based on the operation performance result, detect correction values for each virtual ECU corresponding to the operation timing error, and transmit the calculated correction values to each virtual ECU.

In addition, a computer program according to another aspect of the present invention is combined with a computer as hardware, to execute an error correction method in the system for verifying a virtual ECU, and is stored in a computer readable recording medium.

Other specific details of the present invention are contained in the detailed description and drawings.

According to the present invention described above, it is possible to minimize the operation timing errors that may occur between the real ECU and the virtual ECU. By correcting the errors caused by various factors that occur depending on the host PC environment, it is possible to match the operation of the virtual ECU with the actual ECU as much as possible, which can ensure the accurate operation during the development and verification stages and improve the system stability.

In addition, it is possible to increase the efficiency in the development and verification stages by solving the problems occurring due to the operation timing errors. The test may be performed while maintaining the accurate timing through the error compensation, so it is possible to reduce the development and verification times.

The effects of the present invention are not limited to the effects described above, and other effects not described will be obviously understood by those skilled in the art from the following description.

### BRIEF DESCRIPTION OF THE DRAWINGS

FIG. 1 is a block diagram of a system for verifying a virtual ECU according to an embodiment of the present invention.

FIG. 2 is a configuration diagram of the system for verifying a virtual ECU according to an embodiment of the present invention.

FIG. 3 is a flowchart of a method for correcting error in a virtual ECU according to an embodiment of the present invention.

### DETAILED DESCRIPTION

The advantages and features of the present invention and a method for achieving them will become apparent by referring to the embodiments described in detail below along with the accompanying drawings. However, the present invention is not limited to the embodiments to be disclosed below, but may be implemented in various different forms. The present embodiments will be provided only to make the disclosure of the present invention complete and allow those skilled in the art to completely recognize the scope of the present invention, and the present invention will be only defined by the scope of the claims.

The terms used in the present specification are for explaining the embodiments rather than limiting the present invention. In the present specification, a singular form includes a plural form unless specially stated in the phrase. The terms “comprises” and/or “comprising” used herein do not preclude the presence or addition of one or more other components in addition to the mentioned component. Like reference numerals throughout the specification refer to like components and “and/or” includes each and all combinations of one or more components. Although “a first”, “a second” and the like are used to describe various components, these components are of course not limited by these terms. These terms are used only to distinguish one component from other components. Therefore, it is natural that a first component mentioned below may also be a second component within the technical idea of the present invention.

Unless defined otherwise, all terms (including technical and scientific terms) used in the present specification will be used as a meaning that can be commonly understood by those skilled in the art to which the present invention pertains. In addition, the terms defined in commonly used dictionary are not ideally or excessively interpreted unless explicitly and specially defined.

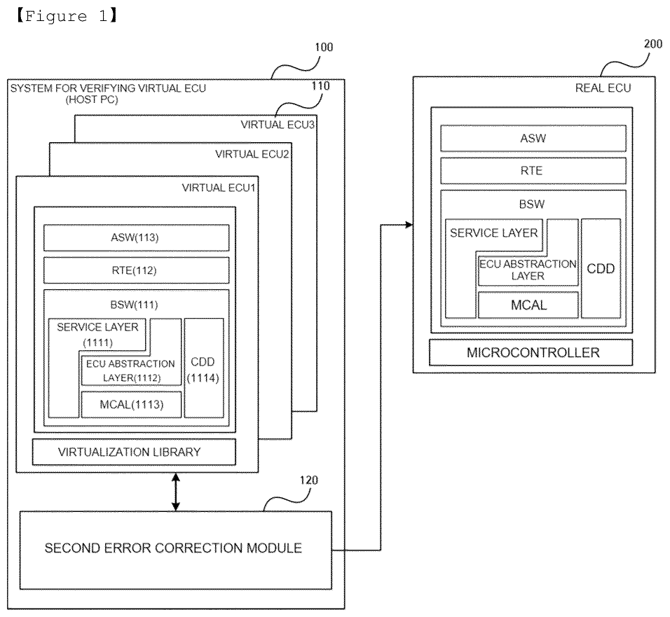

FIG. 1 is a block diagram of a system 100 for verifying a virtual ECU according to an embodiment of the present invention.

The system 100 for verifying a virtual ECU according to an embodiment of the present invention includes a plurality of virtual ECUs 110 and a second error correction module 120.

The plurality of virtual ECUs 110 may be generated on a host PC as a predetermined virtualization library is executed. The virtual ECU 110 may execute firmware applied with the AUTOSAR platform, like a structure of a general vehicle system guided by AUTOSAR, and the AUTOSAR platform includes Basic Software (BSW) 111, a Runtime Environment 112, and Application Software (ASW) 113.

The ASW 113 is an application software layer and is a set of software components. The ASW 113 is a software component, and implements core functions unique to a controller to be developed by OEMs, suppliers, etc.

The RTE 112 serves to exchange and connect data between components of the ASW 113 and between the ASW 113 and the BSW 111. The RTE 112 allows software components implemented in the ASW 113 through the RTE 112 to be used through an API call without any modification.

The BSW 111 separates hardware and software and serves to provide independent application services to hardware. That is, the BSW 111 is a standardized software layer that provides services necessary for software components to perform necessary tasks, and provides services related to input/output, memory, and communication to software components.

Specifically, among the AUTOSAR layers, the BSW 111 largely includes a service layer 1111, an ECU abstraction layer 1112, a Microcontroller Abstraction Layer (MCAL) 1113, and Complex Device Drivers (CDD) 1114.

The service layer 1111 is the uppermost layer among the BSW layers, and provides system services, memory services, communication services, and the like for system operation and overall control of other modules in the BSW.

In this case, the system service performs a function of managing tasks and interrupts. The memory service performs functions for reading and writing to a memory. The communication service provides functions necessary to use various communication protocols in an automotive embedded system.

Next, the ECU abstraction layer 1112 provides an ECU-independent interface to a service layer and an ASW layer. As embodiment, various memory interfaces and communication an interfaces may be implemented according to the ECU through the ECU abstraction layer 1112.

Next, the MCAL 1113 provides a microcontroller-independent specific interface to the abstraction layer. When the AUTOSAR is applied to a microcontroller with a different design, it is possible to call communication, memory, and input/output modules regardless of the microcontroller by using a driver of the MCAL 1113.

Finally, the CDD 1114 is a layer that configures a direct interface from the microcontroller to RTE without being connected to the specific layer, and allows information of the BSW to be directly transmitted to the ASW through the RTE. The CDD 1114 may be used by adding a driver or the like for functions not defined in the AUTOSAR. According to an embodiment of the present invention, the virtual ECU 110 includes a first error correction module (not shown) implemented using the function of the CDD 1114.

The first error correction module corrects the operation timing error between the virtual ECU 110 and the real ECU 200. In order to correct the operation timing error, the first error correction module receives an operation timing measurement start signal for an operation of a predetermined task of the virtual ECU 110, operates a predetermined task based on a preset unit time and number of times of repetitions, and performs an operation timing error correction by applying a correction value transmitted from the second error correction module 120. In addition, the first error correction module terminates the operation timing measurement when the operation of the task is completed.

The second error correction module 120 operates on the host PC, which is the execution environment of the virtual ECU 110. The second error correction module 120 operates by interacting with the first error correction module and, in particular, provides a correction value for correcting the operation timing error to the first error correction module. The second error correction module 120 generates and transmits the operation timing measurement start signal of the plurality of virtual ECUS 110 and the real ECU 200, and receives operation performance results corresponding to a predetermined task from the virtual ECU 110 and the real ECU 200. The second error correction module 120 may calculate an operation timing error between the virtual ECU 110 and the real ECU 200 based on the operation performance results, and detect and provide the correction value for correcting the operation timing error of the virtual ECU 110. Alternatively, the second error correction module 120 may update the firmware by reflecting the correction value and then re-execute the virtual ECU 110 based on the updated firmware.

In this case, the unit time, the number of times of repetitions, and the correction value for correcting the operation timing error may be stored in advance in the memory of the first error correction module and the second error correction module 120.

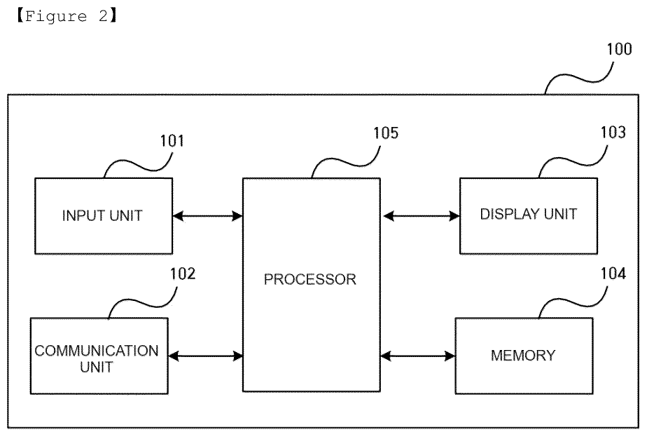

FIG. 2 is a configuration diagram of the system 100 for verifying a virtual ECU according to an embodiment of the present invention.

Referring to FIG. 2, the system 100 for verifying a virtual ECU includes an input unit 101, a communication unit 102, a display unit 103, a memory 104, and a processor 105.

The input unit 101 receives a predetermined input value for operating the system 100 for verifying a virtual ECU from a user. The input unit 101 includes at least one input means. The input unit 101 may include a keyboard, a key pad, a dome switch, a touch panel, a touch key, a mouse, a menu button, and the like.

The communication unit 102 supports transmission and reception of internal data or external data of the system 100 for verifying a virtual ECU. This communication unit 102 may include both a wired communication module and a wireless communication module. The wired communication module may be implemented as a power line communication device, a telephone line communication device, cable home (MoCA), Ethernet, IEEE1294, an integrated wired home network, and an RS-485 control device. In addition, the wireless communication module may be configured in a module for implementing functions such as wireless LAN (WLAN), Bluetooth, HDR WPAN, UWB, ZigBee, Impulse Radio, 60 GHz WPAN, Binary-CDMA, wireless USB technology and wireless HDMI technology, 5th generation (5G) communication, long term evolution-advanced (LTE-A), long term evolution (LTE), and wireless fidelity (Wi-Fi).

The display unit 103 outputs data according to the operation of the system 100 verifying a virtual ECU or displays other usage service screens, etc. The display unit 103 includes a liquid crystal display (LCD), a light emitting diode (LED) display, an organic LED (OLED) display, a micro electro mechanical systems (MEMS) display, and an electronic paper display. The display unit 103 may be coupled with the input unit 101 and implemented as a touch screen.

The memory 104 stores operation programs of the system 100 for verifying a virtual ECU. Here, the memory 104 collectively refers to a non-volatile storage device that continuously maintains stored information even when power is not supplied and a volatile storage device. For example, the memory 104 may include NAND flash memories such as a compact flash (CF) card, a secure digital (SD) card, a memory stick, a solid-state drive (SSD), and a micro SD card, magnetic computer storage devices such as a hard disk drive (HDD), and optical disc drives such as CD-ROM and DVD-ROM, etc.

The processor 105 may control at least one other component (e.g., hardware or software component) of the system 100 for verifying a virtual ECU by executing software, such as a program stored in memory, and perform various data processing or calculations.

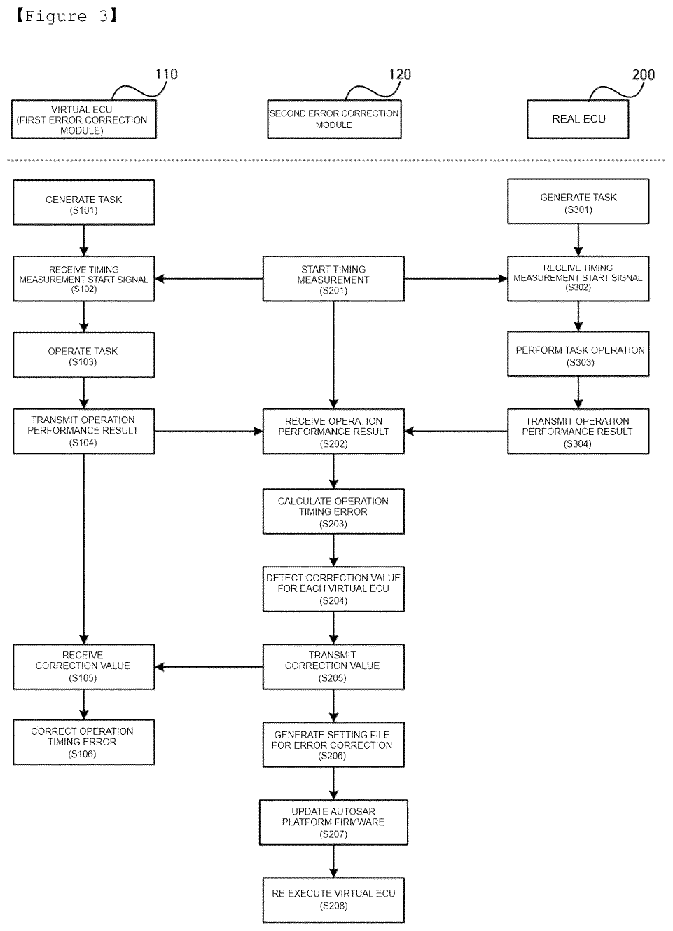

Hereinafter, a method performed by the system 100 for verifying a virtual ECU according to an embodiment of the present invention will be described in detail with reference to FIG. 3.

FIG. 3 is a flowchart of a method for correcting error in a virtual ECU according to an embodiment of the present invention.

First, the first error correction module generates a predetermined task (S101). Likewise, the actual ECU 200 also generates a predetermined task (S301). In this case, the predetermined task may be the same as a task operating in the real ECU 200, and the unit time used while performing the task may be 1 second (sec), 1 millisecond (ms), etc. Meanwhile, in an embodiment of the present invention, the correction process described later may be performed on the premise that the unit time applied to the virtual ECU 110 and the unit time used in the real ECU 200 have a small mutual error.

The unit time represents the reference unit of time used to control the operation of the virtual ECU 110, and represents the time interval during which a specific task or a desired task in the system is performed.

The first error correction module of the virtual ECU 110 may use the unit time to define a virtual task corresponding to the real ECU 200 and control a task operation based on the virtual task. The first error correction module performs a task or a specific operation according to a set unit time, and may perform a simulation or test by repeating this as many times as the number of times of repetitions.

For example, when the unit time of the first error correction module (or virtual ECU) is set to 1 millisecond, the first error correction module may perform a task or a specific operation every 1 millisecond.

Meanwhile, in the embodiment of the present invention, the unit time may be set in various ways according to the user's needs. For example, when the detailed control of the task is required, a smaller unit time may be selected, and conversely, when large amounts of data processing or long work cycles are required, a larger unit time may be selected and applied.

As such, in an embodiment of the present invention, the unit time serves as an important factor for adjusting the operation timing in the virtual ECU 110 and synchronizing it with the real ECU. Therefore, when maintaining the same operation timing as the real ECU, an appropriate unit time should be set and applied in consideration of the task operation cycle of the real ECU.

Next, the second error correction module 120 transmits the timing measurement start signal to the plurality of virtual ECUS 110 and the real ECU 200 (S201). When the first error correction module of the virtual ECU 110 and the real ECU 200 receive the timing measurement start signal through a vehicle interface such as CAN, LIN, or Ethernet (S102 and S302), they perform the operation corresponding to the task based on the preset unit time and number of times of repetitions (S103 and S303), and as the operation performance of the task is completed, transmit the operation performance results to the second error correction module 120 (S104 and S304).

Here, the unit time and number of times of repetitions may use the preset value through the built-in firmware. In other words, before executing the virtual ECU 110, the specific unit time and number of times of repetitions may be built into the firmware and used as fixed values. The unit time and number of times of repetitions may be received from the second error correction module 120 together with the operation timing measurement start signal.

In this case, the unit time and number of times of repetitions applied between the virtual ECU 110 and the real ECU 200 should use the same values. This may be a necessary condition for matching the operations of the virtual ECU 110 and the real ECU 200 and minimizing the operation timing errors. Meanwhile, this is to reduce the measurement error in unit time by performing the above process a predetermined number of times, and the measurement error may be reduced by performing more measurements than one measurement and cumulative averaging the measurements.

In this case, when performing the operation corresponding to the task, the virtual ECU 110 and the real ECU 200 may each measure timing. That is, the virtual ECU 110 may perform the task according to the set unit time and number of times of repetitions, and determine the operation timing by measuring the start and completion times of the task. In addition, the actual ECU may perform the task operation upon receiving the control signal, that is, the operation timing measurement start signal, through the second error correction module 120, and measure the start and completion times of the operation to determine the actual operation timing.

Thereafter, as the test is completed, the second error correction module 120 receives the operation performance result corresponding to the predetermined task from the virtual ECU 110 and the real ECU 200 (S202). The operation timing error between the virtual ECU 110 and the real ECU 200 is calculated based on the operation performance results (S203).

Specifically, the second error correction module 120 measures a first transmission time for transmitting the timing measurement start signal to the virtual ECU 110 and a first reception time for receiving the operation performance result.

The second error correction module 120 measures a second transmission time for transmitting the timing measurement start signal to the real ECU 200 and a second reception time for receiving the operation performance result.

Next, the second error correction module 120 calculates a first communication delay time of the virtual ECU 110 and a second communication delay time of the real ECU 200, respectively.

Then, the second error correction module 120 may calculate the operation timing error based on a comparison result of the first and second transmission times, the first and second reception times, and the first and second communication delay times.

The operation timing error calculated by the second error correction module 120 may be calculated based on Equation 1 below.

$$Error rate = \frac{( {T}_{{real}_{receive}} - {T}_{{real}_{send}} ) - {T}_{{real}_{communication}}}{( {T}_{receive} - {T}_{send} ) - {T}_{communication}} \times 100 \qquad [ Equation 1 ]$$

In Equation 1 above, T_{receive} means the first transmission time in the virtual ECU 110, T_{send} means the first reception time, and T_{communication} means the first communication delay time. Tᵣₑₐₗ_{_{receive}} means the second transmission time in the real ECU 200, Tᵣₑₐₗ_{_{send}} means the second reception time, and Tᵣₑₐₗ_{_{communication}} means the second communication delay time.

Next, the second error correction module 120 detects the correction values for each virtual ECU 110 corresponding to the operation timing error (S204). In an embodiment, the second error correction module 120 may include a correction value table composed of the correction values applied for each error rate section calculated in Equation 1. For example, when the error rate is 0%, the correction value may be 0, and when the error rate is between 0% and 5%, a specific value may be used. By defining the correction values for each section in advance and forming the table with the correction values, when the operation timing error occurs, the corresponding error rate section may be identified and the correction value corresponding to the corresponding section may be read to correct the operation timing of the virtual ECU 110.

Next, the second error correction module 120 transmits the detected correction values to each virtual ECU 110 (S205). The first error correction module of the virtual ECU 110 that receives this may correct the operation timing by changing at least one of the execution cycle and time measuring clock of the task based on the correction value (S105 and S106).

In an embodiment, in order to change the operation timing of the task running on the AUTOSAR classic platform, the clock that manages the execution unit time (system time) should be changed at a service layer (OS Layer) within the AUTOSAR BSW area.

The service layer within the AUTOSAR BSW area serves to provide the basic operating system functions of the system, and in particular, may perform task scheduling and timing management. The execution unit time of the service layer is repeated at a certain cycle depending on the number of times of repetitions, and this cycle may be generated using a clock.

In order to change the execution unit time, the clock should be changed by adjusting or replacing the attributes of the corresponding clock. For example, the execution unit time may be changed by adjusting the frequency of the clock or selecting a different clock source. The changed execution unit time affects the scheduling and timing of the task in the service layer, and the task is executed according to the changed execution unit time, and the desired operation timing may be achieved as the operation timing error is corrected.

In another embodiment, the second error correction module 120 may generate setting information for the error correction for at least one clock corresponding to the task of the virtual ECU 110 based on the correction value (S206), and update the firmware of the AUTOSAR platform on which multiple virtual ECUS 110 operate based on setting information (S207).

As the update of the firmware is completed, the second error correction module 120 may terminate the plurality of executing virtual ECUs 110 and then re-execute the virtual ECUs 110 (S208).

In this case, the principle of changing the operation timing by regenerating the firmware in the second error correction module 120 is because when developing the AUTOSAR classic platform, the setting information may be configured as a file and the firmware may be generated using the corresponding file.

Examples of the setting information files include ‘MCU_cfg.c’, ‘MCU_cfg.h’, ‘Can_cfg.c’, ‘Can_cfg.h’, etc., and the corresponding setting information files may be configured and generated with the setting information tailored to the microcontroller used in the second error correction module 120.

These setting information files may be used in the firmware generation process to regenerate the firmware. The regenerated firmware is applied by replacing or updating the existing firmware. By changing the firmware, in addition to the task execution cycle and the time measuring clock, the overall clock configuration of the system such as a main clock, a communication clock, and a Phase-Locked Loop (PLL) involved in other outputs may be changed. Here, the main clock refers to the overall clock source, the communication clock is a clock used to determine the communication speed, and the PLL refers to a clock-related device used to convert the frequency or generate the output clock.

As such, an embodiment of the present invention may correct the operation timing error in the virtual ECU 110 based on the correction value or correct the operation timing error through a process of regenerating the firmware in the second error correction module 120. Of course, these two error correction methods may be applied independently or simultaneously or at different times.

Meanwhile, in the above description, steps S101 to S304 may be further divided into additional steps or combined into fewer operations according to an implementation example of the present invention. Also, some operations may be omitted if necessary, and an order between operations may also be changed. In addition, even if other contents are omitted, the contents described in FIGS. 1 to 2 and the contents described in FIG. 3 are mutually applied.

The method for correcting error in the system 100 for verifying a virtual ECU according to an embodiment of the present invention described above may be implemented as a program (or application) to be executed in combination with a computer, which is hardware, and stored in a medium.

In order for the computer to read the program and execute the methods implemented as the program, the program may include a code coded in a computer language such as C, C++, JAVA, Ruby, Python, or machine language that the processor (CPU) of the computer may read through a device interface of the computer. This code may include functional code related to a function defining functions necessary for executing the methods and include an execution procedure-related control code necessary for the processor of the computer to execute the functions according to a predetermined procedure. In addition, this code may further include a memory reference-related code that indicates which location (address street number) in an internal or external memory of the computer should be referenced for additional information or media necessary for the processor of the computer to execute the functions. In addition, when the processor of the computer needs to communicate with any other remote computers, servers, or the like in order to execute the above functions, the code may further include a communication-related code for how to communicate with any other remote computers, servers, or the like using the communication module of the computer, what information or media should be transmitted and received during communication, and the like.

The storage medium refers to a medium that stores data semi-permanently and can be read by a device, rather than a medium that stores data for a short period of time, such as a register, a cache, a memory, or the like. Specifically, examples of the storage medium include, but are not limited to, ROM, RAM, CD-ROM, a magnetic tape, a floppy disk, an optical data storage device, and the like. That is, the program may be stored in various recording media on various servers accessible by the computer or in various recording media on the computer of the user. In addition, the media may be distributed to a computer system connected by a network, and a computer-readable code may be stored in a distributed manner.

The aforementioned description of the present invention is for illustrative purposes, and those skilled in the art to which the present invention pertains will understand that it may be easily modified to other specific forms without changing the technical idea or essential features of the present invention. Therefore, it should be understood that the embodiments described above are illustrative in all aspects and not restricted. For example, each component described as a single type may be implemented in a distributed manner, and similarly, components described as distributed may also be implemented in a combined form.

It is to be construed that the scope of the present invention is indicated by the claims described below rather than the detailed description above, and all modifications and alternations derived from the meaning and scope of claims and their equivalent concept are included in the scope of the present invention.

What is claimed is:

1. A method for correcting error in a virtual electronic control unit (ECU) performed by a system for verifying a virtual ECU, the method comprising:
transmitting a timing measurement start signal from an error correction module in a host PC in which a plurality of virtual ECUs are driven to the plurality of virtual ECUs and a real ECU;
receiving an operation performance result corresponding to a predetermined task from the virtual ECU and the real ECU;
calculating an operation timing error between the virtual ECU and the real ECU based on the operation performance result;
detecting correction values for each virtual ECU corresponding to the operation timing error; and
transmitting the detected correction values to each virtual ECU.

2. The method of claim 1, wherein as the plurality of virtual ECUs and the real ECU receive the timing measurement start signal, the plurality of virtual ECUs and the real ECU perform an operation corresponding to the task based on a preset unit time and number of times of repetitions, and as the operation performance of the task is completed, transmit the operation performance result to the second error correction module.

3. The method of claim 2, wherein the same unit time and number of times of repetitions are applied in the plurality of virtual ECUs and the real ECU.

4. The method of claim 1, wherein the plurality of virtual ECUs receive the correction value through a CDD provided in a BSW layer to correct the operation timing error.

5. The method of claim 4, wherein the plurality of virtual ECUs correct the operation timing error by changing at least one of an execution cycle and a time measurement clock of the task based on the correction value.

6. The method of claim 1, wherein the calculating of the operation timing error between the virtual ECU and the real ECU based on the operation performance result includes:
measuring a first transmission time for transmitting the timing measurement start signal to the virtual ECU and a first reception time for receiving the operation performance result;
measuring a second transmission time for transmitting the timing measurement start signal to the real ECU and a second reception time for receiving the operation performance result;
calculating first and second communication delay times of the virtual ECU and the real ECU, respectively; and
calculating the operation timing error based on a comparison result of the first and second transmission times, the first and second reception times, and the first and second communication delay times.

7. The method of claim 6, wherein in the detecting of the correction value for each virtual ECU corresponding to the operation timing error, the operation timing error detects correction values for each corresponding virtual ECU on a correction value table composed of correction values applied for each section.

8. The method of claim 1, further comprising:
generating setting information for error correction for at least one clock corresponding to a task of the virtual ECU based on the correction value;
updating firmware of an AUTOSAR platform on which the plurality of virtual ECUs operate based on the setting information;
terminating the plurality of executing virtual ECUs; and
re-executing the plurality of virtual ECUs.

9. A system for verifying a virtual electronic control unit (ECU), comprising:
a plurality of virtual ECUs that operate within a host PC and include a first error correction module; and
a second error correction module that is provided in the host PC to transmit a timing measurement start signal to the plurality of virtual ECUs and the real ECU, and when receiving an operation performance result corresponding to a predetermined task from the virtual ECUs and the real ECU, calculates an operation timing error between the virtual ECUs and the real ECU based on the operation performance results, detects correction values for each virtual ECU corresponding to the operation timing error, and then transmits the calculated correction values to each virtual ECU.

10. The system of claim 9, wherein as the plurality of virtual ECUs and the real ECU receive the timing measurement start signal, the plurality of virtual ECUs and the real ECU perform an operation corresponding to the task based on a preset unit time and number of times of repetitions, and
the second error correction module receives the operation performance result from the plurality of virtual ECUs and the real ECU as the operation performance of the task is completed.

11. The system of claim 10, wherein the plurality of virtual ECUs and the real ECU apply the same unit time and number of times of repetitions as the preset unit time and number of times of repetitions.

12. The system of claim 9, wherein the plurality of virtual ECUs receive the correction value through a CDD provided in a BSW layer to correct the operation timing error.

13. The system of claim 12, wherein the plurality of virtual ECUs correct the operation timing error by changing at least one of an execution cycle and time measurement clock of the task based on the correction value.

14. The system of claim 9, wherein the second error correction module measures first transmission time for transmitting the timing measurement start signal to the virtual ECU and a first reception time for receiving the operation performance result, measures a second transmission time for transmitting the timing measurement start signal to the actual ECU and a second reception time for receiving the operation performance result, calculates first and second communication delay times of the virtual ECU and the real ECU, respectively, and then calculates the operation timing error based on a comparison result of the first and second transmission times, the first and second reception times, and the first and second communication delay times.

15. The system of claim 9, wherein the second error correction module generates setting information for error correction for at least one clock corresponding to a task of the virtual ECU based on the correction value, updates firmware of an AUTOSAR platform on which the plurality of virtual ECUS operate based on the setting information, and then terminates the plurality of executing virtual ECUs, and re-executes the plurality of virtual ECUs.

16. An error correction module within a host PC equipped with a plurality of virtual electronic control units (ECUs), comprising:
a memory configured to store at least one instruction; and
at least one processor configured to execute the at least one instruction stored in the memory,
wherein the processor executes the instruction to
transmit a timing measurement start signal to the plurality of virtual ECUs and the real ECU, and
when the operation performance result corresponding to the predetermined task is received from the virtual ECU and the real ECU, calculate an operation timing error between the virtual ECU and the real ECU based on the operation performance result,
detect correction values for each virtual ECU corresponding to the operation timing error, and
transmit the calculated correction values to each virtual ECU.
